(19) United States
(12) Patent Application Publication
(10) Pub. No.: US 2015/0243990 A1
(43) Pub. Date: Aug. 27, 2015

(54) CATHODE ACTIVE MATERIAL FOR SODIUM SECONDARY BATTERY, METHOD FOR PREPARING THE SAME AND SODIUM SECONDARY BATTERY EMPLOYING THE SAME

(71) Applicant: KOREA INSTITUTE OF SCIENCE AND TECHNOLOGY, Seoul (KR)

(72) Inventors: Kyung Yoon CHUNG, Seoul (KR); Won Young CHANG, Seoul (KR); Byung Won CHO, Seoul (KR); Ali GHULAM, Seoul (KR); Ji-Young KIM, Seoul (KR)

(21) Appl. No.: 14/528,639

(22) Filed: Oct. 30, 2014

(30) Foreign Application Priority Data
Feb. 24, 2014 (KR) 10-2014-0021158

(51) Int. Cl. H01M 4/583; H01M 10/054; H01M 4/36

(52) U.S. Cl. CPC H01M 4/5835; H01M 4/364; H01M 10/054; H01M 4/366; H01M 2004/028

(57) ABSTRACT

A cathode active material for a sodium secondary battery is provided. The cathode active material includes a FeF_{2.5}(0.5H₂O)-conductive carbon material composite and is prepared by low-temperature non-aqueous precipitation. The FeF_{2.5}(0.5H₂O)-conductive carbon material composite has high capacity and excellent cycle characteristics. In addition, the FeF_{2.5}(0.5H₂O)-conductive carbon material composite is prepared in an easy and economical manner by low-temperature non-aqueous precipitation. Therefore, the use of the FeF_{2.5}(0.5H₂O)-conductive carbon material composite ensures improved performance of the cathode active material. Further provided are a method for preparing the cathode active material and a sodium secondary battery employing the cathode active material.

### CROSS-REFERENCE TO RELATED APPLICATIONS

This application claims priority under 35 U.S.C. §119 to Korean Patent Application No. 10-2014-0021158 filed on Feb. 24, 2014 in the Korean Intellectual Property Office, the disclosure of which is incorporated herein by reference in its entirety.

### BACKGROUND OF THE INVENTION

1. Field of the Invention

The present invention relates to a cathode active material for a sodium secondary battery, a method for preparing the same, and a sodium secondary battery employing the same. More specifically, the present invention relates to a cathode active material For a sodium secondary battery including a composite of a metal fluoride and a carbon material prepared by low-temperature non-aqueous precipitation, a method for preparing the cathode active material, and a sodium secondary battery employing the cathode active material.

2. Description of the Related Art

Since the successful commercialization of lithium secondary batteries, there has been an increased demand for lithium secondary batteries as energy storage media in various electronic devices. Enormous efforts have also been made to improve the performance of lithium secondary batteries. Despite these efforts, however, there are limitations in using lithium secondary batteries as various energy storage media, particularly, those for electric vehicles, plug-in hybrid electric vehicles, and grid stations.

Thus, many efforts have been made to develop alternatives to lithium secondary batteries. Particularly, sodium secondary batteries have received attention as promising alternatives to lithium secondary batteries because of their advantages such as lower fabrication costs and less risk of environmental pollution. Another advantage of sodium secondary batteries is that sodium is more abundant than lithium. However, sodium secondary batteries suffer from limitations in that sodium is more sensitive to air and has an approximately two-fold larger ion volume than lithium. Another limitation of sodium secondary batteries is that the electrode potential of lithium (−3.05 V vs. standard hydrogen electrode) is lower than that of sodium (−2.71 V vs. standard hydrogen electrode).

Due to these limitations, cathode materials of sodium secondary batteries are, in fact, restricted to materials having high capacity and excellent cycle characteristics. In this connection, transition metals are attracting a lot of attention as electrode materials for secondary batteries in that their highest oxidation states can be utilized. However, metal oxides have the problem of low driving voltage, thus being unsuitable for use as cathode materials.

Metal fluorides have a driving voltage of around 3 V. Particularly, FeF₃ is an attractive metal fluoride as a cathode material for lithium secondary batteries and its reaction mechanism has been extensively studied. For example, Ruquang Ma et al. (R. Ma, M. Wang, P. Tao, Y. Wang, C. Cao, G. Shan, S. Yang, L. Xi, C. Y. Chung and Z. Lu, J. Mater. Chem. A, 2013, DOI: 10.1039/C3TA13086J) reported the fabrication of FeF₃/C nanocomposites by dispersing FeF₃ nanocrystals into a porous carbon matrix, the production of a cathode for a lithium secondary battery using the nanocomposites, and the analysis results, including the electrical properties of the cathode. Further, Li et al. (C. Li, L. Gu, J. Tong and J. Maier, ACS Nano, 2011. 5 (4) 2930-2938) reported the preparation of carbon nanotube-wired iron fluorides (FeF_{2.5}.0.5H₂O and FeF₃.0.33H₂O), the production of cathodes for lithium secondary batteries using the composites, and the analysis results, including the electric capacity and performance of the cathodes.

Little research has been conducted on the use of FeF₃ in cathodes of sodium secondary batteries. Thus, there arises a need for an approach to utilize the advantages of sodium secondary batteries over lithium secondary batteries, which have been described above.

### SUMMARY OF THE INVENTION

The present invention has been made in an effort to solve the problems of the prior art and is intended to provide a cathode material for a sodium secondary battery that is easy to prepare while possessing high capacity and excellent cycle characteristics, a method for preparing the cathode material, and a sodium secondary battery employing the cathode material.

According to a first aspect of the present invention, there is provided a cathode active material for a sodium secondary battery including a FeF_{2.5}(0.5H₂O)-conductive carbon material composite.

In one embodiment of the present invention, the FeF_{2.5}(0.5H₂O)-conductive carbon material composite may have a morphology in which the conductive carbon material is coated on the FeF_{2.5}(0.5H₂O).

In a further embodiment of the present invention, the conductive carbon material may be selected from multi-wall nanotubes and reduced graphene oxide.

In another embodiment of the present invention, the conductive carbon material may be present in an amount of 0.1 to 50% by weight, based on the total weight of the FeF_{2.5}(0.5H₂O)-conductive carbon material composite.

According to a second aspect of the present invention, there is provided a method for preparing a cathode active material for a sodium secondary battery by low-temperature non-aqueous precipitation, the method including:
(a) dispersing a conductive carbon material in a solution of 1-butyl-3-methylimidazolium tetrafluoroborate (BMIMBF₄);
(b) mixing the dispersion with ferric nitrate to prepare a FeF_{2.5}(0.5H₂O)-conductive carbon material composite;
(c) washing the FeF_{2.5}(0.5H₂O)-conductive carbon material composite; and
(d) drying the washed FeF_{2.5}(0.5H₂O)-conductive carbon material composite under vacuum.

In one embodiment of the present invention, the low-temperature non-aqueous precipitation may be performed at a temperature ranging from 25° C. to 50° C.

In a further embodiment of the present invention, the conductive carbon material may be selected from multi-wall nanotubes and reduced graphene oxide.

In another embodiment of the present invention, the BMIMBF₄, the ferric nitrate, and the conductive carbon material may be used in a weight ratio of 10:1:0.001 to 10:1:0.5.

According to a third aspect of the present invention, there is provided a sodium secondary battery including the cathode active material.

The FeF_{2.5}(0.5H₂O)-conductive carbon material composite has high capacity and excellent cycle characteristics. In addition, the FeF_{2.5}(0.5H₂O)-conductive carbon material composite is prepared in an easy and economical manner by low-temperature non-aqueous precipitation. The use of the FeF_{2.5}(0.5H₂O)-conductive carbon material composite ensures improved performance of the cathode active material.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an XRD pattern of FeF_{2.5}(0.5H₂O) prepared in Comparative Example 1-1;

FIG. 2 is an XRD pattern of a FeF_{2.5}(0.5H₂O)-MWNT composite prepared in Example 1-1;

FIG. 3 is an XRD of a FeF_{2.5}(0.5H₂O)-RGO composite prepared in Example 2-1;

FIG. 4 is a SEM image of FeF_{2.5}(0.5H₂O) prepared in Comparative Example 1-1;

FIG. 5 is a SEM image of a FeF_{2.5}(0.5H₂O)-MWNT composite prepared in Example 1-1;

FIG. 6 is a SEM image of a FeF_{2.5}(0.5H₂O)-RGO composite prepared in Example 2-1;

FIG. 7 shows the results of charge-discharge tests on a FeF_{2.5}(0.5H₂O)-MWNT composite prepared in Example 1-1 at 0.05 C rate;

FIG. 8 shows the results of charge-discharge cycle tests on a FeF_{2.5}(0.5H₂O)-MWNT composite prepared in Example 1-1 at 0.05 C rate;

FIG. 9 shows the results of charge-discharge tests on a FeF_{2.5}(0.5H₂O)-MWNT composite prepared in Example 1-1 at 0.1 C, 0.25 C and 1 C rates;

FIG. 10 shows the results of charge-discharge cycle tests on a FeF_{2.5}(0.5H₂O)-MWNT composite prepared in Example 1-1 at 0.1 C, 0.25 C and 1 C rates; and

FIG. 11 shows the results of charge-discharge tests on a FeF_{2.5}(0.5H₂O)-RGO composite prepared in Example 2-1 at 0.1 C rate.

### DETAILED DESCRIPTION OF THE INVENTION

The present invention will now be described with reference to the accompanying drawings, in which embodiments of the invention are shown. However, the drawings and embodiments are not to be construed as limiting the scope of the invention.

The present invention provides a cathode active material for a sodium secondary battery including a FeF_{2.5}(0.5H₂O)-conductive carbon material composite. The cathode active material of the present invention has high capacity and excellent cycle characteristics.

The FeF_{2.5}(0.5H₂O)-conductive carbon material composite is easily prepared at reduced cost by low-temperature non-aqueous precipitation.

Hereinafter, a detailed description will be given of the cathode active material of the present invention.

As described above, the cathode active material of the present invention includes a FeF_{2.5}(0.5H₂O)-conductive carbon material composite.

Due to the presence of FeF_{2.5}(0.5H₂O), the cathode active material of the present invention may have the following advantages.

In the cathode active material of the present invention, the FeF_{2.5}(0.5H₂O) phase is more dominantly present than FeF₃(0.33H₂O) phase. This can reduce the preparation cost of the cathode active material. FeF₃(0.33H₂O) requires an additional system or process to maintain a vacuum state due to its inherent characteristics, whereas no system or process is required to handle FeF_{2.5}(0.5H₂O). Accordingly, the cathode active material of the present invention is easy to handle.

FeF_{2.5}(0.5H₂O) can be synthesized at a relatively low temperature ranging from room temperature to room temperature plus about 20° C., when compared to FeF₃(0.33H₂O). Accordingly, FeF_{2.5}(0.5H₂O) is easier to synthesize than FeF₃(0.33H₂O).

The use of FeF_{2.5}(0.5H₂O) in the electrode active material of a sodium secondary battery ensures high capacity, good retention, high coulombic efficiency, and high working voltage of the sodium secondary battery.

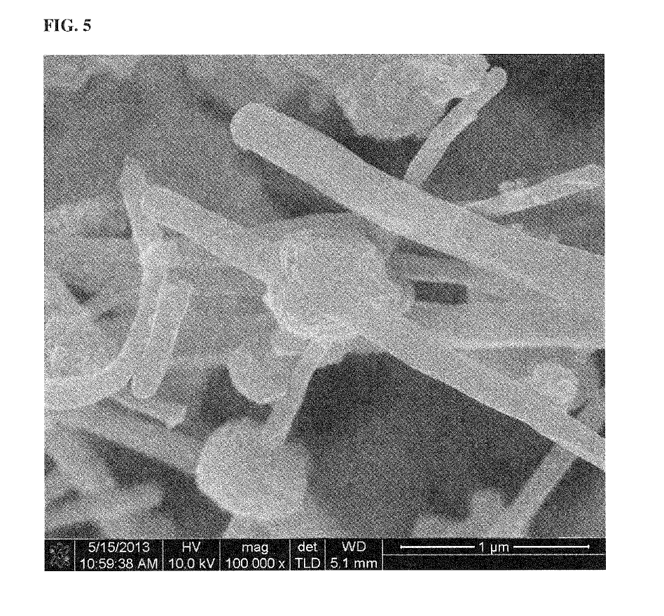

FeF_{2.5}(0.5H₂O) is prepared by low-temperature non-aqueous precipitation, which will be described below. Referring to FIG. 4, FeF_{2.5}(0.5H₂O) has a grain size in the nanometer range, i.e. in the sub-micrometer range.

The cathode active material of the present invention has a morphology in which a conductive carbon material is coated on FeF_{2.5}(0.5H₂O).

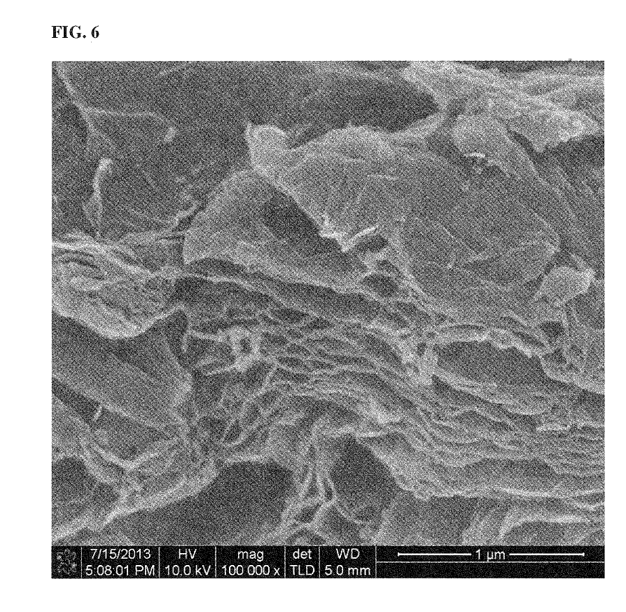

FIGS. 5 and 6 are SEM images of FeF_{2.5}(0.5H₂O)-conductive carbon material composites according to embodiments of the present invention.

Referring to FIGS. 5 and 6, each of the FeF_{2.5}(0.5H₂O)-conductive carbon material composites has a morphology in which the conductive carbon material is coated on the FeF_{2.5}(0.5H₂O). This morphology allows for uniform dispersion of the conductive carbon material in the composite to improve the electrical conductivity of the composite.

Due to this morphology, the grain size of the active material can be reduced, and as a result, the solid phase diffusion velocity in the active material decreases, which increases the electrochemical utilization of the active material.

The above morphological features of the FeF_{2.5}(0.5H₂O)-conductive carbon material composite allow the composite to have excellent electrical characteristics such as high capacity and high output characteristics.

The conductive carbon material of the cathode active material according to the present invention may be selected from multi-wall nanotubes (MWNTs) and reduced graphene oxide.

The conductive carbon material is used to increase the electrical conductivity of the cathode active material.

The cathode active material of the present invention may include 0.1 to 50% by weight of the conductive carbon material, based on the total weight of the FeF_{2.5}(0.5H₂O)-conductive carbon material composite.

The presence of the conductive carbon material in an amount of less than 0.1% by weight is not sufficient to improve the electrical conductivity of the composite. Meanwhile, the presence of the conductive carbon material in an amount exceeding 50% by weight brings about a reduction in electric capacity due to the reduced content of the FeF_{2.5}(0.5H₂O).

The present invention also provides a method for preparing a cathode active material for a sodium secondary battery by low-temperature non-aqueous precipitation, the method including:
(a) dispersing a conductive carbon material in a solution of 1-butyl-3-methylimidazolium tetrafluoroborate (BMIMBF₄);
(b) mixing the dispersion with ferric nitrate to prepare a FeF_{2.5}(0.5H₂O)-conductive carbon material composite;
(c) washing the FeF_{2.5}(0.5H₂O)-conductive carbon material composite; and
(d) drying the washed FeF_{2.5}(0.5H₂O)-conductive carbon material composite under vacuum.

According to the method of the present invention, a FeF_{2.5}(0.5H₂O)-conductive carbon material composite may be prepared by low-temperature non-aqueous precipitation. Specifically, the FeF_{2.5}(0.5H₂O)-conductive carbon material composite is prepared by the following procedure. First, a precursor, a reactant, and a conductive carbon material are weighed. The conductive carbon material is uniformly dispersed with stirring in the reactant, and the dispersion is mixed with the precursor to obtain the desired composite. Alternatively, in the case where the precursor is first mixed with the reactant instead of uniformly dispersing the conductive carbon material in the reactant, a single-phase metal fluoride is first formed as a result of the reaction of the precursor with the reactant, making it impossible to obtain the composite coated with the conductive carbon material.

The as-prepared composite may contain organic impurities. The organic impurities need to be removed by washing. After washing, the composite is dried under vacuum. The dried composite can be used to prepare a cathode active material for a sodium secondary battery.

The use of the low-temperature non-aqueous precipitation in the method of the present invention enables the preparation of the cathode active material in a simple manner at low cost, as described above. That is, the low-temperature non-aqueous precipitation offers great advantages in the preparation of the cathode active material.

In the method of the present invention, the low-temperature non-aqueous precipitation is performed at a temperature ranging from 25° C. to 50° C.

If the low-temperature non-aqueous precipitation is performed at a temperature lower than 25° C. an additional process is needed to increase the temperature to or above room temperature. Meanwhile, if the low-temperature non-aqueous precipitation is performed at a temperature exceeding 50° C., the phase of FeF_{2.5}(0.5H₂O) may be deformed.

In the method of the present invention, the conductive carbon material may be selected from multi-wall nanotubes and reduced graphene oxide. The conductive carbon material is used to increase the electrical conductivity of the cathode active material, as described above.

In the method of the present invention, the BMIMBF₄, the ferric nitrate, and the conductive carbon material arc used in a weight ratio of 10:1:0.001 to 10:1:0.5.

The use of the conductive carbon material in an amount of less than the lower limit (i.e. 0.001) is not sufficient to improve the electrical conductivity of the composite. Meanwhile, the use of the conductive carbon material in an amount exceeding than the upper limit (i.e. 0.5) brings about a reduction in electric capacity due to the reduced content of the FeF_{2.5}(0.5H₂O).

The FeF_{2.5}(0.5H₂O)-conductive carbon material composite may be washed using a centrifuge. In the course of centrifugation, the composite is preferably washed using an organic solvent such as acetone.

The present invention also provides a sodium secondary battery including a cathode, a counter electrode, a separator, and an electrolyte.

The cathode contains the cathode active material of the present invention. The cathode may be produced by loading an electrode material on an electrode current collector. The electrode material includes the cathode active material, a conductive material, and a binder.

The binder may be, for example, a thermoplastic resin. Specific examples of such thermoplastic resins include: fluorinated resins, such as polyvinylidene fluoride (PVDF) and polytetrafluoroethylene; and polyolefin resins, such as polyethylene and polypropylene. The conductive material may be, for example, natural graphite, artificial graphite, carbon black or Denka black. The electrode current collector may be, for example, aluminum (Al), nickel (Ni) or stainless steel.

The electrode material may be loaded on the electrode current collector by molding under pressure. Alternatively, the electrode material may be loaded on the electrode current collector by the following procedure. First, an organic solvent is used to prepare the electrode material into a paste. As the organic solvent, there may be exemplified an amine-based solvent, an ether-based solvent, a ketone-based solvent. an ester-based solvent, or an aprotic polar solvent. Then, the paste is coated on the electrode current collector, dried, and pressed. As a result of the pressing, the paste is fixed to the electrode current collector. The electrode material is coated on the electrode current collector by any suitable technique, such as slit die coating or screen coating.

The counter electrode is produced by loading a counter electrode material including a counter electrode active material on a counter electrode current collector. Alternatively, the counter electrode may be a sodium metal or sodium alloy electrode capable of intercalating and deintercalating sodium ions.

Examples of materials suitable for the separator include polyolefin resins and fluorinated resins.

The electrolyte may be, for example, a solution of NaClO₄, NaPF₆ or NaBF₄ in an organic solvent. The organic solvent may be, for example, a carbonate-based solvent, an ether-based solvent, or an ester-based solvent.

The present invention will be explained in more detail with reference to the following examples. However, these examples are provided to assist in understanding the invention and are not intended to limit the scope of the invention.

### EXAMPLES

### Example 1-1

### FeF_{2.5}(0.5H₂O)-MWNT Composite

10 mL of 1-butyl-3-methylimidazolium tetrafluoroborate (BMIMBF₄, Aldrich, >98%), 1 gr of ferric nitrate (Fe(NO₃)₃.9H₂O, Aldrich, 99.99%), and 10 wt % of multi-wall carbon nanotubes (MWNTs) with respect to the weight of the ferric nitrate were prepared.

First, the pre-weighed MWNTs were mixed with the BMIMBF₄ (10 ml), and then the mixture was stirred with a magnetic bar for 1 hr to prepare a solution in which the MWNTs were uniformly dispersed.

Thereafter, the pre-weighed ferric nitrate was poured into the solution. The mixture was stirred at 50° C. for 14 hr to obtain a FeF_{2.5}(0.5H₂O)-MWNT composite.

The FeF_{2.5}(0.5H₂O)-MWNT composite was placed in a centrifuge and washed with acetone. The centrifuge was operated at 5,000 rpm for 5 min. This procedure was repeated five times to remove organic impurities formed in, the course of preparing the composite. Thereafter, the washed FeF_{2.5}(0.5H₂O)-MWNT composite was dried under vacuum at 80° C. for 20 hr. FIG. 2 shows the results of X-ray diffraction analysis for the final product, and FIG. 5 shows a SEM image of the final product.

### Example 1-2

### Sodium Secondary Battery Employing the FeF_{2.5}(0.5H₂O)-MWNT Composite as Cathode Active Material

The FeF_{2.5}(0.5H₂O)-MWNT composite (0.39 gr) prepared in Example 1-1, Denka black (0.195 gr) as a conductive material, and PVDF (1.2999 gr) as a binder were mixed in a weight ratio of 60:30:10. To the mixture was added NMP as an organic solvent until a uniform viscosity was obtained. The resulting mixture was prepared into a paste. Then, the paste was applied onto an aluminum foil and dried at 80° C. for 4 hr. Subsequently, the coated aluminum foil was pressed using a rolling press to produce a cathode including the FeF_{2.5}(0.5H₂O)-MWNT composite.

The cathode including the FeF_{2.5}(0.5H₂O)-MWNT composite, a polypropylene (PP) separator, and a sodium counter electrode were assembled to fabricate a half cell of a sodium secondary battery. 1 M NaClO₄ was dissolved in an organic solvent of propylene carbonate (PC), ethylene carbonate (EC) and diethylene carbonate (DEC) in a ratio of 1:1:1 to prepare an electrolyte. The electrolyte was injected into the cell. The half cell was fabricated in a glove box filled with argon gas containing ≦0.1 ppm H₂O and O₂.

### Example 2-1

### FeF_{2.5}(0.5H₂O)-RGO Composite

10 mL of 1-butyl-3-methylimidazolium tetrafluoroborate (BMIMBF₄, Aldrich, >98%), 1 gr of ferric nitrate (Fe(NO₃)₃.9H₂O, Aldrich, 99.99%), and 10 wt % of reduced graphene oxide (RGO) with respect to the weight of the ferric nitrate were prepared.

First, the pre-weighed RGO was mixed with the BMIMBF₄ (10 ml), and then the mixture was stirred with a magnetic bar for 1 hr to prepare a solution in which the RGO was uniformly dispersed.

Thereafter, the pre-weighed ferric nitrate was poured into the solution. The mixture was stirred at 50° C. for 14 hr to obtain a FeF_{2.5}(0.5H₂O)-RGO composite.

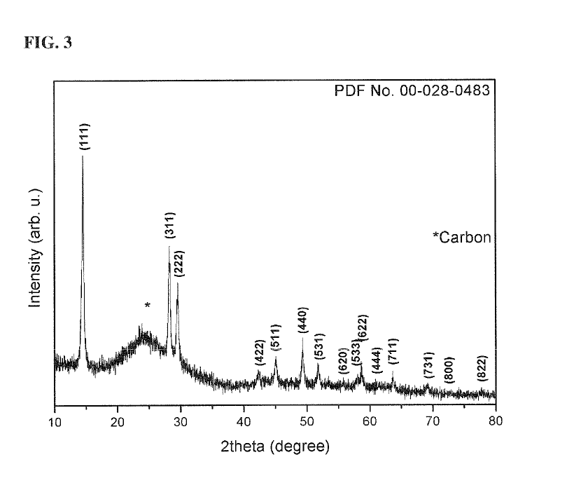

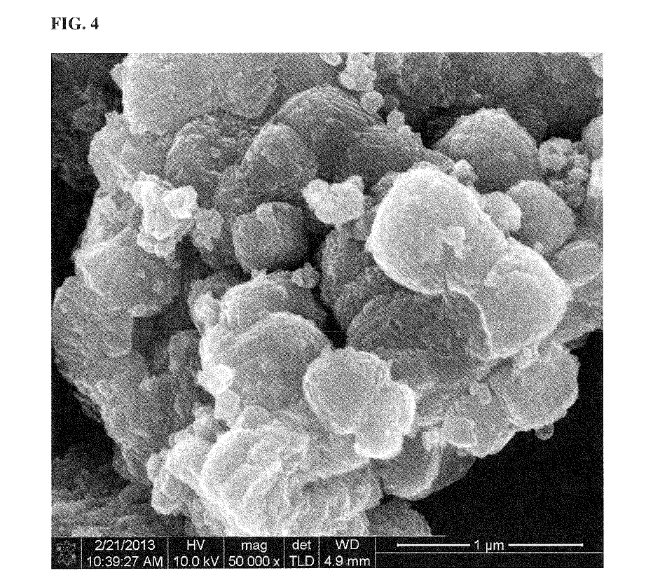

The FeF_{2.5}(0.5H₂O)-RGO composite was placed in a centrifuge and washed with acetone. The centrifuge was operated at 5,000 rpm for 5 min. This procedure was repeated five times to remove organic impurities formed in the course of preparing the composite. Thereafter, the washed FeF_{2.5}(0.5H₂O)-RGO composite was dried under vacuum at 80° C. for 20 hr. FIG. 3 shows the results of X-ray diffraction analysis for the final product, and FIG. 6 shows a SEM image of the final product.

### Example 2-2

### Sodium Secondary Battery Employing the FeF_{2.5}(0.5H₂O)-RGO Composite

The FeF_{2.5}(0.5H₂O)-RGO composite (0.39 gr) prepared in Example 2-1, Denka black (0.195 gr) as a conductive material, and PVDF (1.2999 gr) as a binder were mixed in a weight ratio of 60:30:10. To the mixture was added NMP as an organic solvent until a uniform viscosity was obtained. The resulting mixture was prepared into a paste. Then, the paste was applied onto an aluminum foil and dried at 80° C. for 4 hr. Subsequently, the coated aluminum foil was pressed using a rolling press to produce a cathode including the FeF_{2.5}(0.5H₂O)-RGO composite.

The cathode including the FeF_{2.5}(0.5H₂O)-RGO composite, a polypropylene (PP) separator, and a sodium counter electrode were assembled to fabricate a half cell of a sodium secondary battery. 1 M NaClO₄ was dissolved in an organic solvent of propylene carbonate (PC), ethylene carbonate (EC) and diethylene carbonate (DEC) in a ratio of 1:1:1 to prepare an electrolyte. The electrolyte was injected into the cell. The half cell was fabricated in a glove box filled with argon gas containing ≦0.1 ppm H₂O and O₂.

### Comparative Example 1-1

### FeF_{2.5}(0.5H₂O)

10 mL of 1-butyl-3-methylimidazolium tetrafluoroborate (BMIMBF₄, Aldrich, >98%) and 1 gr of ferric nitrate (Fe(NO₃)₃.9H₂O, Aldrich, 99.99%) were prepared.

First, the pre-weighed ferric nitrate (1 gr) was dissolved in the BMIMBF₄ (10 ml), and then the solution was stirred with a magnetic bar at 50° C. for 6 hr to obtain FeF_{2.5}(0.5H₂O).

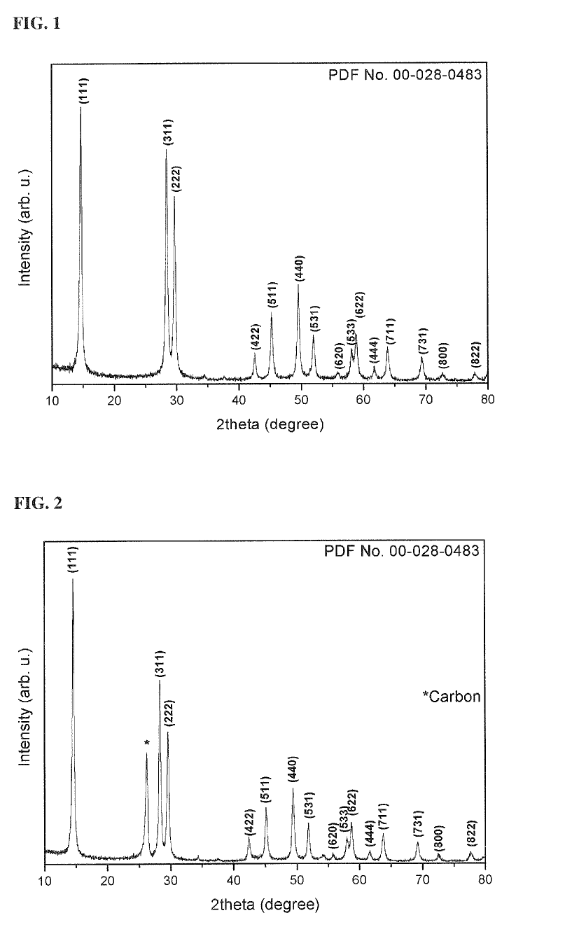

The FeF_{2.5}(0.5H₂O) was placed in a centrifuge and washed with acetone. The centrifuge was operated at 5,000 rpm for 5 min. This procedure was repeated five times to remove organic impurities formed in the course of preparing the FeF_{2.5}(0.5H₂O). Thereafter, the washed FeF_{2.5}(0.5H₂O) was dried under vacuum at 80° C. for 20 hr. FIG. 1 shows the results of X-ray diffraction analysis for the final product, and FIG. 4 shows a SEM image of the final product.

### Comparative Example 1-2

### Sodium Secondary Battery Employing the FeF_{2.5}(0.5H₂O)

The FeF_{2.5}(0.5H₂O) prepared in Comparative Example 1-1, Denka black (0.195 gr) as a conductive material, and PVDF (1.2999 gr) as a binder were mixed in a weight ratio of 60:30:10. To the mixture was added NMP as an organic solvent until a uniform viscosity was obtained. The resulting mixture was prepared into a paste. Then, the paste was applied onto an aluminum foil and dried at 80° C. for 4 hr. Subsequently, the coated aluminum foil was pressed using a rolling press to produce a cathode including the FeF_{2.5}(0.5H₂O).

The cathode including the FeF_{2.5}(0.5H₂O), a polypropylene (PP) separator, and a sodium counter electrode were assembled to fabricate a half cell of a sodium secondary battery. 1 M NaClO₄ was dissolved in an organic solvent of propylene carbonate (PC), ethylene carbonate (EC) and diethylene carbonate (DEC) in a ratio of 1:1:1 to prepare an electrolyte. The electrolyte was injected into the cell. The half cell was fabricated in a glove box filled with argon gas containing ≦0.1 ppm H₂O and O₂.

### TEST EXAMPLES

### Test Example 1

### X-Ray Diffraction Tests

FIG. 1 is an XRD pattern of the FeF_{2.5}(0.5H₂O) prepared in Comparative Example 1-1.

FIG. 2 is an XRD pattern of the FeF_{2.5}(0.5H₂O)-MWNT composite prepared in Example 1-1.

FIG. 3 is an XRD of the FeF_{2.5}(0.5H₂O)-RGO composite prepared in Example 2-1.

FIGS. 1 to 3 show the presence of carbon in the composites of Examples 1-1 and 2-1.

Test Example 2

### Scanning Electron Microscope (SEM) Images

FIG. 4 is a SEM image of the FeF_{2.5}(0.5H₂O) prepared in Comparative Example 1-1.

FIG. 5 is a SEM image of the FeF_{2.5}(0.5H₂O)-MWNT composite prepared in Example 1-1.

FIG. 6 is a SEM image of the FeF_{2.5}(0.5H₂O)-RGO composite prepared in Example 2-1.

Referring to FIGS. 4 to 6, the FeF_{2.5}(0.5H₂O), the FeF_{2.5}(0.5H₂O)-MWNT composite and the FeF_{2.5}(0.5H₂O)-RGO composite had grain sizes in the nanometer range, i.e. in the sub-micrometer range, and were good in aggregate state.

### Test Example 3

### Charge-Discharge Tests and Charge-Discharge Cycle Tests of the Sodium Secondary Batteries

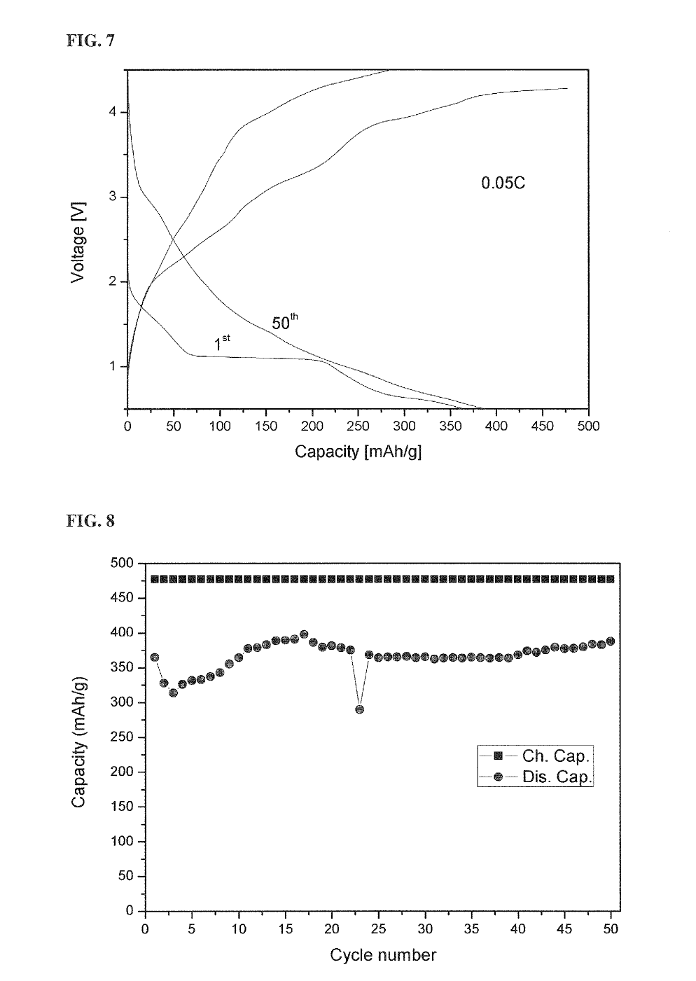

FIG. 7 shows the results of charge-discharge tests on the cell fabricated in Example 1-2 at 0.05 C rate.

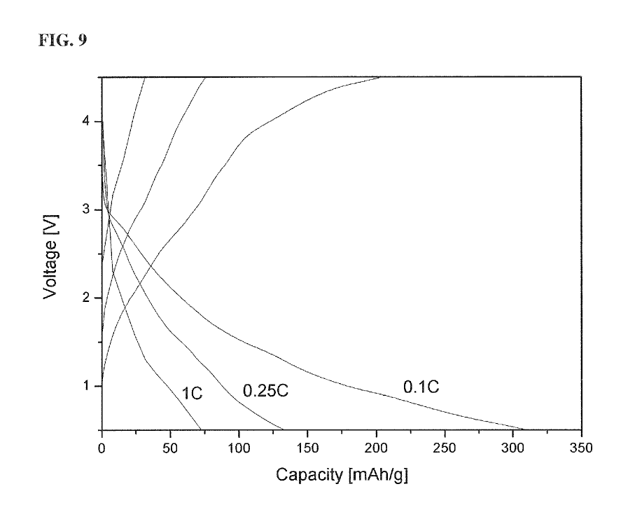

FIG. 8 shows the results of charge-discharge cycle tests on the cell fabricated in Example 1-2 at 0.05 C rate.

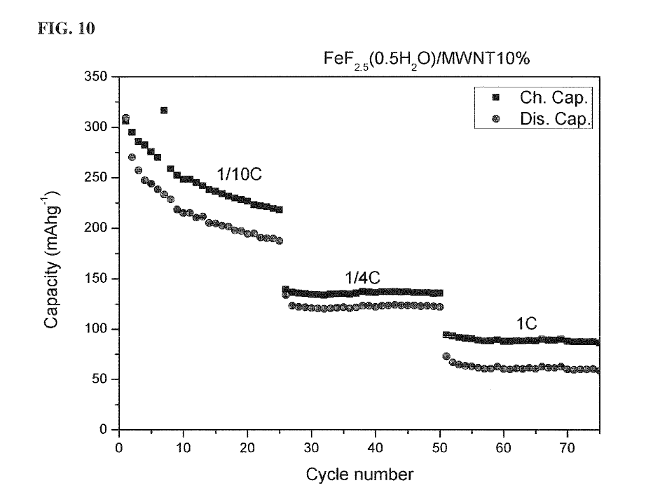

FIG. 9 shows the results of charge-discharge tests on the cell fabricated in Example 1-2 at 0.1 C, 0.25 C and 1 C rates;

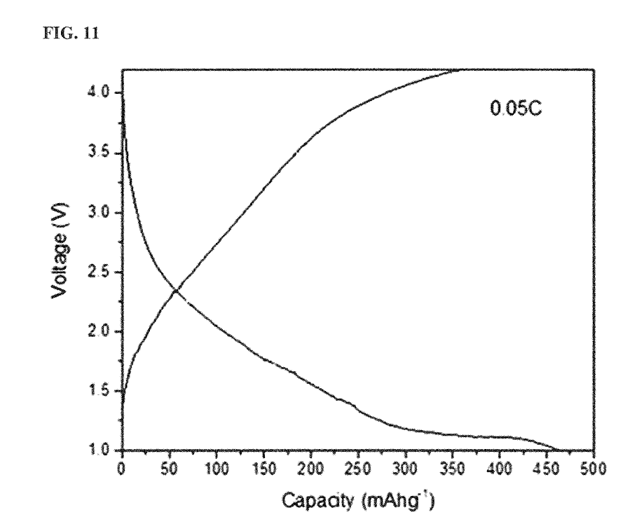

FIG. 10 shows the results of charge-discharge cycle tests on the cell fabricated in Example 1-2 at 0.1 C, 0.25 C and 1 C rates; and

FIG. 11 shows the results of charge-discharge tests on the cell fabricated in Example 2-2 at 0.1 C rate.

Referring to FIGS. 7 and 8, after 50 cycles of charging and discharging, the cell of Example 1-2 showed a discharge capacity of 370 mAh/g at 0.05 C rate and in the voltage range of 0.5-4.5 V.

Referring to FIGS. 9 and 10, after 25 cycles of charging and discharging, the cell of Example 1-2 showed a discharge capacity of 185 mAh/g at 0.1 C rate and in the voltage range of 0.5-4.5 V, a discharge capacity of 125 mAh/g at 0.25 C rate and in the voltage range of 0.5-4.5 V, and a discharge capacity of 70 mAh/g at 1 C rate and in the voltage range of 0.5-4.5 V.

Referring to FIG. 11, after one cycle of charging and discharging, the cell of Example 2-2 showed a discharge capacity of 460 mAh/g at 0.05 C rate and in the voltage range of 1.0-4.2 V.

These results lead to the conclusion that the cathode active materials for sodium secondary batteries including the FeF_{2.5}(0.5H₂O)-conductive carbon material composites have high capacities and excellent cycle characteristics.

What is claimed is:

1. A cathode active material for a sodium secondary battery comprising a FeF_{2.5}(0.5H₂O)-conductive carbon material composite.

2. The cathode active material according to claim 1, wherein the FeF_{2.5}(0.5H₂O)-conductive carbon material composite has a morphology in which the conductive carbon material is coated on the FeF_{2.5}(0.5H₂O).

3. The cathode active material according to claim 1, wherein the conductive carbon material is selected from multi-wall nanotubes and reduced graphene oxide.

4. The cathode active material according to claim 1, wherein the conductive carbon material is present in an amount of 0.1 to 50% by weight, based on the total weight of the FeF_{2.5}(0.5H₂O)-conductive carbon material composite.

5. A method for preparing a cathode active material for a sodium secondary battery by low-temperature non-aqueous precipitation, the method comprising:
(a) dispersing a conductive carbon material in a solution of 1-butyl-3-methylimidazolium tetrafluoroborate (BMIMBF₄);
(b) mixing the dispersion with ferric nitrate to prepare a FeF_{2.5}(0.5H₂O)-conductive carbon material composite;
(c) washing the FeF_{2.5}(0.5H₂O)-conductive carbon material composite; and
(d) drying the washed FeF_{2.5}(0.5H₂O)-conductive carbon material composite under vacuum.

6. The method according to claim 5, wherein the low-temperature non-aqueous precipitation is performed at a temperature ranging from 25° C. to 50° C.

7. The method according to claim 5, wherein the conductive carbon material is selected from multi-wall nanotubes and reduced graphene oxide.

8. The method according to claim 5, wherein the BMIMBF₄, the ferric nitrate, and the conductive carbon material are used in a weight ratio of 10:1:0.001 to 10:1:0.5.

9. A sodium secondary battery comprising the cathode active material according to claim 1.
